(19) United States
(12) Patent Application Publication
(10) Pub. No.: US 2010/0243456 A1
(43) Pub. Date: Sep. 30, 2010

(54) MOLTEN SALT BATH, METHOD FOR PREPARING THE SAME, AND TUNGSTEN FILM

(75) Inventors: Koji NITTA, Osaka (JP); Masatoshi Majima, Osaka (JP); Shinji Inazawa, Osaka (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 12/727,857

(22) Filed: Mar. 19, 2010

(30) Foreign Application Priority Data
Mar. 27, 2009 (JP) 2009-079800

(51) Int. Cl. B32B 3/00; C25D 1/04; C25D 3/66

(52) U.S. Cl. 205/50; 205/76; 205/261

(57) ABSTRACT

A molten salt bath contains tungsten and has a water content of 100 ppm or less and an iron content of 500 ppm or less. The molten salt bath from which high-quality tungsten can be stably deposited, a method for preparing the molten salt bath, and a tungsten film are provided.

### BACKGROUND OF THE INVENTION

1. Field of the Invention

The present invention relates to a molten salt bath, a method for preparing the molten salt bath, and a tungsten film.

2. Description of the Related Art

For manufacturing metal products by electroforming or coating substrates, conventionally, a metal is deposited from a bath by electrolysis. In particular, it is expected that the technique of depositing a metal by electrolysis can be applied to the manufacture of micro metal products used for microelectromechanical systems (MEMS) or the coating of such micro metal products. MEMS is a technique that can manufacture small, multifunctional, energy-saving micro metal products, and receives attention in various fields, such as of information communication, medical care, biotechnology and automobiles.

Tungsten is a metal superior in heat resistance and mechanical strength, and accordingly micro metal products manufactured from tungsten or coated with tungsten can exhibit high heat resistant and durability.

Unfortunately, tungsten has a larger ionization tendency than water, and water is preferentially electrolyzed in an aqueous solution containing tungsten. Tungsten deposition by electrolysis using an aqueous solution is difficult and has not been reported.

A non-patent literature (Koichiro Koyama et al., “Design of Molten Salt Bath on the Basis of Acid-Base Cooperative Reaction Mechanism, Smooth Electrodeposition of Tungsten from KF-B2O3-WO3 Molten Salt”, J. Electrochem, Soc., Vol. 67, No. 6, 1999, pp. 677-683) proposes that tungsten be deposited by electrolyzing an 850° C. KF-B₂O₃—WO₃ molten salt bath. It is considered this method can form a smooth tungsten deposition film.

However, the quality of tungsten films deposited by the above method is not always stable. An improved method is desired.

### SUMMARY OF THE INVENTION

Accordingly, the present invention provides a molten salt bath from which high-quality tungsten can be stably deposited, a method for preparing the molten salt bath, and a tungsten film.

According to an aspect of the present invention, a molten salt bath containing tungsten is provided. The molten salt bath may contain 100 ppm or less of water and 500 ppm or less of iron.

Preferably, the molten salt bash has a lead content of 100 ppm or less.

Preferably, the molten salt bash has a copper content of 30 ppm or less.

Preferably, the molten salt bath further contains silicon.

Preferably, the content of the silicon is 5% by mass or less in the molten salt bath.

According to another aspect of the present invention, a method is provided for preparing the molten salt bath. The method includes the steps of: drying a solid raw material; melting the solid raw material to prepare a molten salt bath precursor after the step of drying; and electrolyzing the molten salt bath precursor.

According to still another aspect of the present invention, a tungsten film is provided which has a thickness T and a surface roughness Ra and satisfies the relationship Ra/T≦0.7.

Also a tungsten film formed using the molten salt bath is provided. The tungsten film has a thickness T and a surface roughness Ra and satisfies the relationship Ra/T≦0.7.

Values with “ppm” and “% by mass” used herein represent impurity contents relative to the total mass of the molten salt bath.

The present invention can provides a molten salt bath from which high-quality tungsten can be deposited, a method for preparing the molten salt bath, and a tungsten film.

### BRIEF DESCRIPTION OF THE DRAWINGS

FIG. 1 is a schematic representation of an apparatus for forming a tungsten film using a molten salt bath according to an embodiment of the present invention.

FIG. 2 is a schematic representation of an apparatus used in Experimental Examples 1 to 8 of the present invention.

### DESCRIPTION OF THE PREFERRED EMBODIMENTS

Embodiments of the present invention will now be described. The same reference numerals in the drawings designate the same parts or equivalents.

### Composition of Molten Salt Bath

A molten salt bath according to an embodiment of the present invention contains tungsten, and has a water content of 100 ppm or less and an iron content of 500 ppm or less. The present inventors have found through intensive research that electrolysis of a tungsten-containing molten salt bath for tungsten deposition can form a dense and pure tungsten film having a smooth surface by controlling the contents of water and iron, which are impurities in the molten salt bath, to 100 ppm or less and 500 ppm or less, respectively.

The molten salt bath may be selected from the following (1) to (4), and each molten salt bath has a water content of 100 ppm or less and an iron content of 500 ppm or less. However, the molten salt bath of embodiments of the present invention is not limited to the following four, and any molten salt bath can be uses as long as tungsten can be deposited by electrolysis.

(1) KF-B₂O₃-WO₃ both (mixture of KF, B₂O₃ and WO₃)
(2) ZnCl₂—NaCl—KCl—KF-WO₃ bath (mixture of ZnCl₂, NaCl, KCl, KF and WO₃)
(3) Li₂WO₄—Na₂WO₄-K₂WO₄—LiCl—NaCl—KCl—KF bath (mixture of Li₂WO₄, Na₂WO₄, K₂WO₄, LiCl, NaCl, KCl and KF)
(4) NaBr—KBr—CsBr—WCl₄ bath (mixture of NaBr, KBr, CsBr and WCl₄)

Preferably, the water content in the molten salt bath is 75 ppm or less from the viewpoint of increasing the surface smoothness, density and purity of the tungsten film formed by electrolysis of the molten salt bath.

Also, the iron content in the molten salt bath is preferably 360 ppm or less from the viewpoint of increasing the surface smoothness, density and purity of the tungsten film formed by electrolysis of the molten salt bath.

The molten salt bath may contain lead as an impurity, and its content is preferably 100 ppm or less, more preferably 50 ppm or less. The molten salt bath having such a lead content tends to increase the surface smoothness, density and purity of the tungsten film formed by electrolysis of the molten salt bath.

The molten salt bath may contain copper as an impurity, and its content is preferably 30 ppm or less. The molten salt bath having such a copper content tends to increase the surface smoothness, density and purity of the tungsten film formed by electrolysis of the molten salt bath.

Preferably, the molten salt bath contains silicon, and its content is preferably 5% by mass or less relative to the entirety of the molten salt bath. The molten salt bath containing silicon, particularly containing 5% by mass or less of silicon, tends to increase the surface smoothness of the tungsten film formed by electrolysis of the molten salt bath.

More preferably, the silicon content in the molten salt bath is 0.34% by mass or less from the viewpoint of increasing the surface smoothness of the tungsten film formed by electrolysis of the molten salt bath.

Still more preferably, the silicon content in the molten salt bath is 0.01% by mass or more from the viewpoint of increasing the surface smoothness of the tungsten film.

The water content in the molten salt bath can be measured with a microwave moisture meter in an atmosphere having a dew-point temperature of −75° C. or less.

Other metal impurity contents in the molten salt bath can be measured by, for example, inductively coupled plasma (ICP) spectrometry of a solution of the molten salt bath in a mixture of nitric acid and hydrofluoric acid.

The metal impurities can be any form in the molten salt bath without particular limitation, and may be present in ion form or complex form. The main constituents including tungsten can be present any form without particular limitation, and may be present in ion form or complex form.

### Preparation of Molten Salt Bath

The molten salt bath can be prepared as below. First, solid raw materials of the main constituents of the molten salt bath are dried (drying step). This step removes water from the solid raw materials.

For drying the solid raw materials, for example, the solid raw materials are each placed in a pressure-proof vessel or a crucible, and the interior of the vessel or crucible is evacuated.

Possible solid raw materials for the main constituents of the molten salt bath include, for example, powder of tungsten compounds, such as WO₃ and WCl₄, and powder of alkaline metal halogenides, such as ZnCl₂, NaCl, KCl and KF.

Then, the dried solid raw materials are melted to prepare a molten salt bath precursor (melting step). This step prepares a molten salt bath precursor containing impurities not controlled to the contents in the molten salt bath specified in the present embodiment of the invention.

The solid raw materials can be melted by, for example, heating a vessel containing the solid raw materials to a temperature at which the solid raw materials can be melted. The temperature at which the solid raw materials can be melted depends on the solid raw materials.

Subsequently, the molten salt bath precursor is electrolyzed (electrolyzing step). This step removes metal impurities, such as iron, lead and copper, and water from the molten salt bath precursor.

The electrolysis of the molten salt bath precursor can be performed by, for example, applying a voltage between an anode and a cathode immersed in the molten salt bath precursor to feed a current to the molten salt bath precursor (first electrolysis) and subsequently applying a voltage between the anode and the cathode so as to feed a current having a higher current density than the current in the first electrolysis to the molten salt bath precursor (second electrolysis). By performing such a two-step electrolysis, water, iron, copper, lead and other impurities can be removed from the molten salt bath precursor. Although the second electrolysis may not be performed, it is preferable that the second electrolysis be performed after the first electrolysis from the viewpoint of removing more impurities.

The impurities, such as water and iron, in the molten salt bath precursor are reduced to the above specified level through the steps of drying, melting and electrolyzing, and thus a molten salt bath is prepared.

The method for preparing the molten salt bath may include another step in addition to the above steps of drying, melting and electrolyzing.

Various modifications may be made in the method for preparing the molten salt bath without particular limitation as long as the water content and the iron content can be controlled as above.

### Tungsten Film

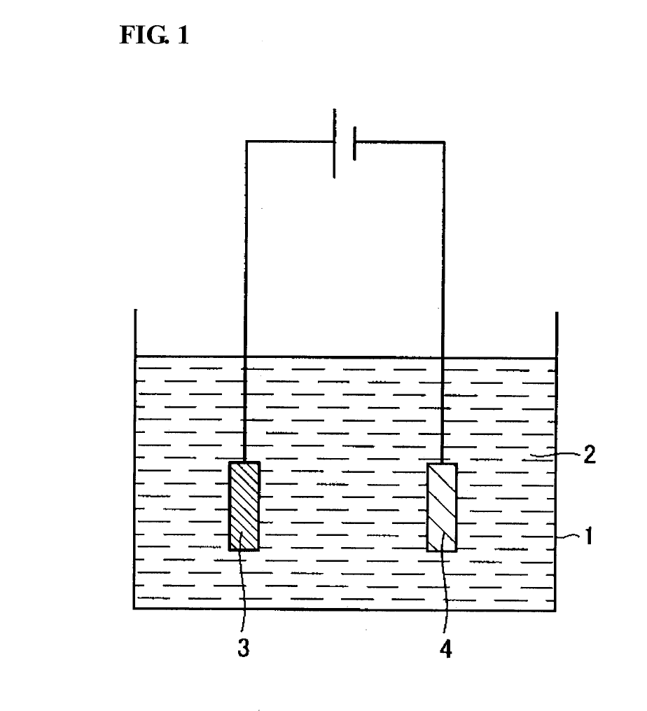

The molten salt bath prepared by the above-described method is placed in a container 1 for electrolysis (hereinafter referred to as electrolysis container 1) as shown in the schematic representation of FIG. 1. A node 3 and a cathode 4 are immersed in the molten salt bath 2 in the electrolysis container 1, and then a current is applied between the anode 3 and the cathode 4 to electrolyze the molten salt bath 2. Thus, the tungsten in the molten salt bath 2 is deposited on the surface of the cathode 4 to form a tungsten film.

Since in the molten salt bath of embodiments of the present invention, the contents of impurities, water and iron, are controlled as above, high-quality tungsten can be stably deposited. The resulting tungsten film is superior to tungsten films formed by electrolyzing known molten salt baths in surface smoothness, density and purity.

In particular, the tungsten film formed by electrolyzing the molten salt bath of embodiments of the present invention can be controlled so that the ratio of the surface roughness Ra to the thickness T can be 0.7 or less (Ra/T≦0.7). The molten salt bath of embodiments of the present invention can form a tungsten film having such a smooth surface.

The resulting tungsten film can be used for radio frequency microelectromechanical systems (RFMEMS) including contact probes, microconnectors, miniature relays, various sensor components, variable capacitors, inductors, arrays and antennas, optical MEMS members, ink jet heads, biosensor inner electrodes, and power MEMS members (e.g. electrodes).

### EXAMPLES

### Experimental Example 1

After enclosing 319 g of KF powder and 133 g of WO₃ powder in respective pressure-proof vessels, the pressure-proof vessels were held at 500° C. and evacuated for two day or more to dry the KF powder and the WO₃ powder.

Also, 148 g of B₂O₃ powder was enclosed in another pressure-proof vessel, and the pressure-proof vessel was held at 380° C. and evacuated for two days or more to dry the B₂O₃ powder.

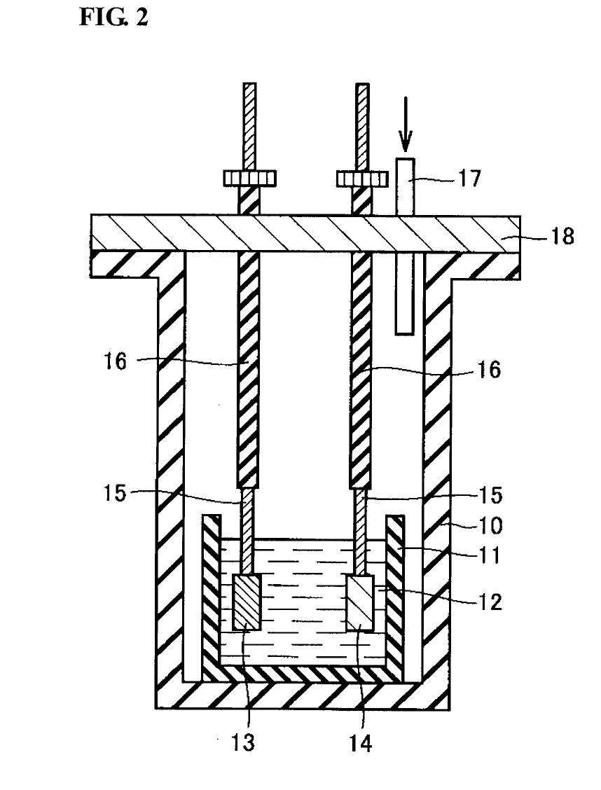

Then a molten salt bath was prepared from the dried KF powder, B₂O₃ powder and WO₃ powder using an apparatus shown in the schematic representation of FIG. 2.

More specifically, the dried KF powder, B₂O₃ powder and WO₃ powder were placed in a SiC crucible 11 dried at 500° C. for two days or more, and the crucible 11 containing the powders was enclosed in a quartz vacuum-proof vessel 10.

While the crucible 11 was held at 500° C. in the vacuum-proof vessel 10 closed with a stainless steel (SUS 316L) cover 18, the vacuum-proof vessel 10 was evacuated for one day or more.

Then, high-purity argon gas was introduced into the vacuum-proof vessel 10 through a gas inlet 17 to fill the interior of the vacuum-proof vessel 10. In this state the crucible 11 was held at 850° C. to melt the powders, and a molten salt bath precursor 12 was thus prepared.

Subsequently, a bar electrode including a tungsten plate 13 (surface area: 20 cm²) acting as the anode and a bar electrode including a nickel plate 14 (surface area: 20 cm²) acting as the cathode were inserted from the opening provided with the cover 18. The tungsten plate 13 and the nickel plate 14 were thus immersed in the molten salt bath precursor 12 in the crucible 11.

The tungsten plate 13 and the nickel plate 14 were each connected to a lead wire 15. The portion of the lead wire 15 inside the vacuum-proof vessel 10 was made of tungsten, and the portion of the lead wire 15 outside the vacuum-proof vessel 10 was made of copper. Each lead wire 15 was partially covered with an alumina covering material 16.

When the bar electrodes were inserted, high-purity argon gas was introduced into the vacuum-proof vessel 10 through the gas inlet 17 to prevent the atmospheric air from entering the vacuum-proof vessel 10.

In order to prevent impurities produced by oxidation of the tungsten plate 13 and the nickel plate 14 from contaminating the molten salt bath precursor 12, the entire surfaces of the tungsten plate 13 and the nickel plate 14 were immersed in the molten salt bath precursor 12, as shown in FIG. 2.

The molten salt bath of Experimental Example 1 was thus prepared by removing impurities from the molten salt bath precursor 12. The resulting molten salt bath contained 0.23% by mass of H₂O and 860 ppm of Fe.

The H₂O content in the molten salt bath of Experimental Example 1 was obtained by measuring an aliquot sampled from the molten salt bath in the crucible 11, enclosed in a vacuum vessel, using a microwave moisture meter in a glove box having a dew-point temperature of −75° C.

The contents of Fe and other metal impurities in the molten salt bath of Experimental Example 1 were obtained by measuring a solution of the molten salt bath in a mixture of nitric acid and hydrofluoric acid by ICP spectrometry.

The nickel plate 14 on which impurities were deposited was replaced with new one, and a current having a current density of 3 A/dm² was applied between the tungsten plate 13 and the nickel plate 14 for one hour. Thus, tungsten was deposited to form a tungsten film of Experimental Example 1 on the surface of the nickel plate 14 by galvanostatic electrolysis of the molten salt bath.

The resulting tungsten film was measured for the surface roughness Ra (μm), the thickness T (μm), the number of voids and the purity (%). The results are shown in the Table.

The surface roughness Ra (μm) shown in the Table was obtained by calculating the average of 10 measurements of the arithmetical mean deviation of the assessed profile Ra (JIS B0601-1994) of a 50 μm square sample with a laser microscope (VK-8500, manufactured by KEYENCE CORPORATION). The smaller the Ra value (μm) shown in the Table, the smoother the surface of the tungsten deposition film.

The thickness T (μm) shown in the Table was obtained by subtracting the thickness of the nickel plate 14 measured in advance from the average of the total thicknesses of the composite of the tungsten film and the nickel plate 14 measured at 5 points with a micrometer. The larger the thickness T (μm) shown in the Table, the larger thickness the tungsten film has.

The number of voids shown in the Table was obtained by observing voids in a section exposed by grinding the tungsten film embedded in an epoxy resin through an scanning electron microscope (SEM) of a magnification of 1500 times. The number of voids of 0.1 μm or more was counted in ten areas of the section. The smaller the number of voids shown in the Table, the higher density the tungsten film has.

The purity (%) shown in the Table was measured as below. First, a tungsten film was formed on an iron plate by electrolyzing the molten salt bath in the same manner as in Experimental Example 1 except that the nickel plate 14 was replaced with the iron plate. Then, the iron plate was dissolved in dilute nitric acid to take the tungsten film. The tungsten film was dissolved in nitrohydrochloric acid, and the resulting solution was subjected to ICP spectrometry to measure the purity of the tungsten. The larger the purity (%) shown in the Table, the higher purity the tungsten film has.

### Experimental Example 2

A molten salt bath of Experimental Example 2 was prepared in the same manner as in Experimental Example 1, except that after a mixture of KF power, B₂O₃ powder and WO₃ powder was melted to prepare a molten salt bath precursor 12, galvanostatic electrolysis was performed by applying a current having a current density of 10 A/dm² between the tungsten plate 13 and the nickel plate 14 immersed in the molten salt bath precursor 12. Impurity contents in the resulting molten salt bath were controlled as shown in the Table.

The contents of impurities in the resulting molten salt bath were measured in the same manner as in Experimental Example 1. The H₂O content was 75 ppm; the Fe content, 360 ppm; the Pb content, 260 ppm; the Cu content, 65 ppm. The Si content was less than 10 ppm (lower than or equal to sensitivity limit).

Tungsten was deposited to form a tungsten film of Experimental Example 2 on the surface of the nickel plate 14 by galvanostatic electrolysis of the molten salt bath under the same conditions as in Experimental Example 1.

The resulting tungsten film was measured for the surface roughness Ra (μm), the thickness T (μm), the number of voids and the purity (%) in the same manner as in Experimental Example 1. The results are shown in the Table.

### Experimental Example 3

A molten salt bath of Experimental Example 3 was prepared in the same manner as in Experimental Example 1, except that after a mixture of KF power, B₂O₃ powder and WO₃ powder was melted to prepare a molten salt bath precursor 12, galvanostatic electrolysis was performed by applying a current having a current density of 0.5 A/dm² between the tungsten plate 13 and the nickel plate 14 immersed in the molten salt bath precursor 12 and then further applying a current having a current density of 10 A/dm².

The contents of impurities in the resulting molten salt bath were measured in the same manner as in Experimental Example 1. The H₂O content was 69 ppm; the Fe content, 300 ppm; the Pb content, 50 ppm; the Cu content, less than 10 ppm (lower than or equal to sensitivity limit). The Si content was less than 10 ppm (lower than or equal to sensitivity limit).

Tungsten was deposited to form a tungsten film of Experimental Example 3 on the surface of the nickel plate 14 by galvanostatic electrolysis of the molten salt bath under the same conditions as in Experimental Example 1.

The resulting tungsten film was measured for the surface roughness Ra (μm), the thickness T (μm), the number of voids and the purity (%) in the same manner as in Experimental Example 1. The results are shown in the Table.

### Experimental Example 4

A molten salt bath of Experimental Example 4 was prepared in the same manner as in Experimental Example 1, except that after a mixture of KF power, B₂O₃ powder and WO₃ powder was melted to prepare a molten salt bath precursor 12, galvanostatic electrolysis was performed by applying a current having a current density of 0.5 A/dm² between the tungsten plate 13 and the nickel plate 14 immersed in the molten salt bath precursor 12 and further applying a current having a current density of 10 A/dm², and then 4.3 g of SiO₂ powder was added to the molten salt bath precursor 12.

The contents of impurities in the resulting molten salt bath were measured in the same manner as in Experimental Example 1. The H₂O content was 69 ppm; the Fe content, 300 ppm; the Pb content, 50 ppm; the Cu content, less than 10 ppm (lower than or equal to sensitivity limit). The Si content was 0.34% by mass.

Tungsten was deposited to form a tungsten film of Experimental Example 4 on the surface of the nickel plate 14 by galvanostatic electrolysis of the molten salt bath under the same conditions as in Experimental Example 1.

The resulting tungsten film was measured for the surface roughness Ra (μm), the thickness T (μm), the number of voids and the purity (%) in the same manner as in Experimental Example 1. The results are shown in the Table.

### Experimental Example 5

A molten salt bath of Experimental Example 5 was prepared in the same manner as in Experimental Example 1, except that 453 g of ZnCl₂ powder, 65 g of NaCl powder, 83 g of KCl powder, 20 g of KF powder, and 14 g of WO₃ powder were used.

Powders having a melting point of 500° C. or more were dried by evacuating the pressure-proof vessel enclosing the powder for two days or more with the pressure-proof vessel held at 500° C.

Powders having a melting point of less than 500° C. were dried by evacuating the pressure-proof vessel enclosing the powder for two days or more with the pressure-proof vessel held at a temperature 100° C. lower than the melting point.

Then a molten salt bath was prepared from the dried ZnCl₂ powder, NaCl powder, KCl powder, KF powder and WO₃ powder using the apparatus shown in the schematic representation of FIG. 2.

More specifically, the dried ZnCl₂ powder, NaCl powder, KCl powder, KF powder and WO₃ powder were placed in a SiC crucible 11 dried at 400° C. for two days or more, and the crucible 11 containing the powders was enclosed in a quartz vacuum-proof vessel 10.

While the crucible 11 was held at 150° C. in the vacuum-proof vessel 10 closed with a SUS 316L cover 18, the vacuum-proof vessel 10 was evacuated for three days or more.

Then, high-purity argon gas was introduced into the vacuum-proof vessel 10 through a gas inlet 17 to fill the interior of the vacuum-proof vessel 10. In this state the crucible 11 was held at 250° C. to melt the powders, and a molten salt bath precursor 12 was thus prepared.

Subsequently, a bar electrode including a tungsten plate 13 (surface area: 20 cm²) acting as the anode and a bar electrode including a nickel plate 14 (surface area: 20 cm²) acting as the cathode were inserted from the opening provided with the cover 18. The tungsten plate 13 and the nickel plate 14 were thus immersed in the molten salt bath precursor 12 in the crucible 11.

The contents of impurities in the resulting molten salt bath were measured in the same manner as in Experimental Example 1. The H₂O content was 0.36% by mass; the Fe content, 650 ppm; the Pb content, 120 ppm; and the Cu content, 42 ppm. The Si content was less than 10 ppm (lower than or equal to sensitivity limit).

The nickel plate 14 on which impurities were deposited was replaced with new one, and a current was applied between the tungsten plate 13 and the nickel plate 14 for one hour with the voltage between the two plates kept at 80 mV. Thus, tungsten was deposited to form a tungsten film of Experimental Example 5 on the surface of the nickel plate 14 by galvanostatic electrolysis of the molten salt bath.

The resulting tungsten film was measured for the surface roughness Ra (μm), the thickness T (μm), the number of voids and the purity (%) in the same manner as in Experimental Example 1. The results are shown in the Table.

### Experimental Example 6

A molten salt bath of Experimental Example 6 was prepared in the same manner as in Experimental Example 5, except that after a mixture of ZnCl₂ power, NaCl powder, KCl powder, KF powder and WO₃ powder was melted to prepare a molten salt bath precursor 12, galvanostatic electrolysis was performed by applying a current having a current density of 0.5 A/dm² between the tungsten plate 13 and the nickel plate 14 immersed in the molten salt bath precursor 12 and further applying a current having a current density of 10 A/dm².

The contents of impurities in the resulting molten salt bath were measured in the same manner as in Experimental Example 5. The H₂O content was 95 ppm; the Fe content, 51 ppm; the Pb content, less than 10 ppm (lower than or equal to sensitivity limit); and the Cu content, less than 10 ppm (lower than or equal to sensitivity limit). The Si content was less than 10 ppm (lower than or equal to sensitivity limit).

Tungsten was deposited to form a tungsten film of Experimental Example 6 on the surface of the nickel plate 14 by galvanostatic electrolysis of the molten salt bath under the same conditions as in Experimental Example 5.

The resulting tungsten film was measured for the surface roughness Ra (μm), the thickness T (μm), the number of voids and the purity (%) in the same manner as in Experimental Example 5. The results are shown in the Table.

### Experimental Example 7

A molten salt bath of Experimental Example 7 was prepared in the same manner as in Experimental Example 1, except that 74 g of Li₂WO₄ powder, 266 g of Na₂WO₄ powder, 223 g of K₂WO₄ powder, 9 g of LiCl powder, 26 g of NaCl powder and 12 g of KF powder were used.

Powders having a melting point of 500° C. or more were dried by evacuating the pressure-proof vessel enclosing the powder for two days or more with the pressure-proof vessel held at 500° C.

Powders having a melting point of less than 500° C. were dried by evacuating the pressure-proof vessel enclosing the powder for two days or more with the pressure-proof vessel held at a temperature 100° C. lower than the melting point.

Then a molten salt bath was prepared from the dried Li₂WO₄ powder, Na₂WO₄ powder, K₂WO₄ powder, LiCl powder, NaCl powder, KCl powder and KF powder using the apparatus shown in the schematic representation of FIG. 2.

More specifically, the dried Li₂WO₄ powder, Na₂WO₄ powder, K₂WO₄ powder, LiCl powder, NaCl powder, KCl powder and KF powder were placed in a SiC crucible 11 dried at 400° C. for two days or more, and the crucible 11 containing the powders was enclosed in a quartz vacuum-proof vessel 10.

While the crucible 11 was held at 400° C. in the vacuum-proof vessel 10 closed with a SUS 316L cover 18, the vacuum-proof vessel 10 was evacuated for three days or more.

Then, high-purity argon gas was introduced into the vacuum-proof vessel 10 through a gas inlet 17 to fill the interior of the vacuum-proof vessel 10. In this state the crucible 11 was held at 600° C. to melt the powders, and a molten salt bath precursor 12 was thus prepared.

Subsequently, a bar electrode including a tungsten plate 13 (surface area: 20 cm²) acting as the anode and a bar electrode including a nickel plate 14 (surface area: 20 cm²) acting as the cathode were inserted from the opening provided with the cover 18. The tungsten plate 13 and the nickel plate 14 were thus immersed in the molten salt bath precursor 12 in the crucible 11.

The contents of impurities in the resulting molten salt bath were measured in the same manner as in Experimental Example 1. The H₂O content was 0.23% by mass; the Fe content, 720 ppm; the Pb content, 100 ppm; and the Cu content, 32 ppm. The Si content was less than 10 ppm (lower than or equal to sensitivity limit).

The nickel plate 14 on which impurities were deposited was replaced with new one, and a current having a current density of 2 A/dm² was applied between the tungsten plate 13 and the nickel plate 14 for two hours. Thus, tungsten was deposited to form a tungsten film of Experimental Example 7 on the surface of the nickel plate 14 by galvanostatic electrolysis of the molten salt bath.

The resulting tungsten film was measured for the surface roughness Ra (μm), the thickness T (μn), the number of voids and the purity (%) in the same manner as in Experimental Example 1. The results are shown in the Table.

### Experimental Example 8

A molten salt bath of Experimental Example 8 was prepared in the same manner as in Experimental Example 7, except that after a mixture of Li₂WO₄ powder, Na₂WO₄ powder, K₂WO₄ powder, LiCl powder, NaCl powder, KCl powder and KF powder was melted to prepare a molten salt bath precursor 12, galvanostatic electrolysis was performed by applying a current having a current density of 0.5 A/dm² between the tungsten plate 13 and the nickel plate 14 immersed in the molten salt bath precursor 12 and further applying a current having a current density of 10 A/dm².

The contents of impurities in the resulting molten salt bath were measured in the same manner as in Experimental Example 7. The H₂O content was 75 ppm; the Fe content, 40 ppm; the Pb content, less than 10 ppm (lower than or equal to sensitivity limit); and the Cu content, less than 10 ppm (lower than or equal to sensitivity limit). The Si content was less than 10 ppm (lower than or equal to sensitivity limit).

Tungsten was deposited to form a tungsten film of Experimental Example 8 on the surface of the nickel plate 14 by galvanostatic electrolysis of the molten salt bath under the same conditions as in Experimental Example 7.

The resulting tungsten film was measured for the surface roughness Ra (μm), the thickness T (μm), the number of voids and the purity (%) in the same manner as in Experimental Example 7. The results are shown in the Table.

TABLE

| | | | Experimantal | | Experimantal | | Experimantal | | Experimantal | | Experimantal | | Experimantal | | Experimantal | | Experimantal | |
|---|---|---|---|---|---|---|---|---|---|---|---|---|---|---|---|---|---|---|
| | | | example 1 | | example 2 | | example 3 | | example 4 | | example 5 | | example 6 | | example 7 | | example 8 | |
| Mol- | Main | Salt | KF | 319 g | KF | 319 g | KF | 319 g | KF | 319 g | ZnCl₂ | 453 g | ZnCl₂ | 453 g | Li₂WO₄ | 74 g | Li₂WO₄ | 74 g |
| ten | con- | | B₂O₃ | 148 g | B₂O₃ | 148 g | B₂O₃ | 148 g | B₂O₃ | 148 g | NaCl | 65 g | NaCl | 65 g | Na₂WO₄ | 266 g | Na₂WO₄ | 266 g |
| salt | stitu- | | WO₃ | 133 g | WO₃ | 133 g | WO₃ | 133 g | WO₃ | 133 g | KCl | 83 g | KCl | 83 g | K₂WO₄ | 223 g | K₂WO₄ | 223 g |

| | | | | | | | | | | | | | |
|---|---|---|---|---|---|---|---|---|---|---|---|---|---|
| bath | ent | — | — | — | — | KF | 20 g | KF | 20 g | LiCl | 9 g | LiCl | 9 g |
| com- | | — | — | — | — | WO₃ | 14 g | WO₃ | 14 g | NaCl | 26 g | NaCl | 26 g |

| | | | | | | | | | | |
|---|---|---|---|---|---|---|---|---|---|---|
| po- | — | — | — | — | — | — | KCl | 26 g | KCl | 26 g |
| sition | — | — | — | — | — | — | KF | 12 g | KF | 12 g |

| | | | | | | | | | |
|---|---|---|---|---|---|---|---|---|---|
| Im- | H₂O | 0.23% | 75 ppm | 69 ppm | 69 ppm | 0.36% | 95 ppm | 0.23% | 75 ppm |
| puri- | Fe | 860 ppm | 360 ppm | 300 ppm | 300 ppm | 650 ppm | 51 ppm | 720 ppm | 40 ppm |
| ty | Pb | — | 260 ppm | 50 ppm | 50 ppm | 120 ppm | <10 ppm | 100 ppm | <10 ppm |
| | Cu | — | 65 ppm | <10 ppm | <10 ppm | 42 ppm | <10 ppm | 32 ppm | <10 ppm |
| | Si | — | <10 ppm | <10 ppm | 0.34% | <10 ppm | <10 ppm | <10 ppm | <10 ppm |

| | | | | | | | | | |
|---|---|---|---|---|---|---|---|---|---|
| Con- | Current | 3 | 3 | 3 | 3 | — | — | 2 | 2 |
| di- | density | | | | | | | | |
| tions | (A/dm²) | | | | | | | | |
| | Electrolysis | — | — | — | — | 80 mV | 80 mV | — | — |
| | potential | | | | | vs. Zn(II)/Zn | vs. Zn(II)/Zn | | |
| | Electrolysis | 1 | 1 | 1 | 1 | 6 | 6 | 2 | 2 |
| | time | | | | | | | | |
| | (hr) | | | | | | | | |
| | Electrolysis | 15 | 18 | 18 | 18 | 0.3 | 0.4 | 4.5 | 4.6 |
| | rate | | | | | | | | |
| | (μm/hr) | | | | | | | | |
| Eval- | Ra (μm) | 53.2 | 12.6 | 7.8 | 4.3 | 1.3 | 0.6 | 6.8 | 1.5 |
| ua- | Thickness | 15 | 18 | 18 | 18 | 1.7 | 2.3 | 8.9 | 9.1 |
| tion | T (μm) | | | | | | | | |
| | Ra/T | 3.55 | 0.7 | 0.43 | 0.24 | 0.76 | 0.26 | 0.76 | 0.16 |
| | Number of | 62 | 0 | 0 | 0 | 25 | 0 | 132 | 0 |
| | voids | | | | | | | | |
| | Purity (%) | 97 | 99.8 | 99.9 | 99.9 | 95.2 | 99.9 | 89 | 99 |

### Evaluation

Although the molten salt baths of Experimental Examples 1 to 4 were prepared from the same raw material powders, as shown in the Table, the tungsten films of Experimental Examples 2 to 4, which were formed by electrolyzing the respective molten salt baths of Experimental Examples 2 to 4 having a H₂O content of 100 ppm or less and an Fe content of 500 ppm or less, had smoother surfaces, fewer voids, higher densities and higher purities than the tungsten film of Experimental Example 1, which was formed by electrolyzing the molten salt bath of Experimental Example 1 having a H₂O content of 0.23% by mass and an Fe content of 860 ppm.

The Table also shows that the tungsten films of Experimental Examples 3 and 4, which were formed by electrolyzing the respective molten salt baths of Experimental Examples 3 and 4 having a Pb content of 100 ppm or less and a Cu content of 30 ppm, exhibited smoother surfaces and higher purities than the tungsten film of Experimental Example 2, which was formed by electrolyzing the molten salt bath of Experimental Example 2 having a Pb content of 260 ppm and a Cu content of 65 ppm.

The Table further shows that the tungsten film of Experimental Example 4, which was formed by electrolyzing the molten salt bath of Experimental Example 4 containing 0.34% by mass of Si, exhibited a smoother surface than the tungsten film of Experimental Example 3, which was formed by electrolyzing the molten salt bath of Experimental Example 3 containing 10 ppm or less of Si.

Although the molten salt baths of Experimental Examples 5 and 6 were prepared from the same raw material powders, as shown in the Table, the tungsten film of Experimental Example 6, which was formed by electrolyzing the molten salt bath of Experimental Example 6 having a H₂O content of 100 ppm or less and an Fe content of 500 ppm or less, had smoother surface, fewer voids, higher density and higher purity than the tungsten film of Experimental Example 5, which was formed by electrolyzing the molten salt bath of Experimental Example 5 having a H₂O content of 0.36% by mass and an Fe content of 650 ppm.

Although the molten salt baths of Experimental Examples 7 and 8 were prepared from the same raw material powders, the tungsten film of Experimental Example 8, which was formed by electrolyzing the molten salt bath of Experimental Example 8 having a H₂O content of 100 ppm or less and an Fe content of 500 ppm or less, had smoother surface, fewer voids, higher density and higher purity than the tungsten film of Experimental Example 7, which was formed by electrolyzing the molten salt bath of Experimental Example 7 having a H₂O content of 0.23% by mass and an Fe content of 720 ppm.

While the present invention has been described with reference to exemplary embodiments and examples, it is to be understood that the invention is not limited to the disclosed exemplary embodiments and examples. The scope of the invention is set forth in the attached claims and encompasses all modifications and equivalent structures and functions within the scope of the invention.

The present invention can be applied to a molten salt bath, a method for preparing a molten salt bath, and a tungsten film.

What is claimed is:

1. A molten salt bath comprising tungsten, the molten salt bath having a water content of 100 ppm or less and an iron content of 500 ppm or less.

2. The molten salt bath according to claim 1, wherein the molten salt bath has a lead content of 100 ppm or less.

3. The molten salt bath according to claim 1, wherein the molten salt bath has a copper content of 30 ppm or less.

4. The molten salt bath according to claim 1, further comprising silicon.

5. The molten salt bath according to claim 4, wherein the content of the silicon is 5% by mass or less in the molten salt bath.

6. A method for preparing the molten salt bath as set forth in claim 1, the method comprising the steps of: drying a solid raw material; melting the solid raw material to prepare a molten salt bath precursor after the step of drying; and electrolyzing the molten salt bath precursor.

7. A tungsten film having a thickness T and a surface roughness Ra, satisfying the relationship Ra/T≦0.7.

8. A tungsten film formed using the molten salt bath as set forth in claim 1, wherein the tungsten film has a thickness T and a surface roughness Ra and satisfies the relationship Ra/T≦0.7.
